(19) United States
(12) Patent Application Publication
(10) Pub. No.: US 2005/0145557 A1
(43) Pub. Date: Jul. 7, 2005

(54) Portable multiple filtration device to demonstrate end result

(76) Inventor: Charles Edmed Hamilton, Tewksbury, MA (US)

Correspondence Address: CHARLES E. HAMILTON, 1186 MAIN STREET, TEWKSBURY, MA, 01876, US

(21) Appl. No.: 11/009,486

(22) Filed: Dec. 11, 2004

Related U.S. Application Data
(60) Provisional application No. 60/481,803, filed on Dec. 17, 2003.

(51) Int. Cl. B01D 24/00

(52) U.S. Cl. 210/348

(57) ABSTRACT

This device is for demonstration purposes, comprising of six containers, whose overall surface is transparent, with containers, mounted on a holder. From supply source, substance is delivered to a container by way of clear tubing, containing a medium, passing through medium, exiting container, or delivered to another container, containing a medium, passing through medium, exiting container, or delivered to, limitless containers, containing a medium, passing through medium, exiting container, for end result of the substance being passed through medium or limitless mediums. Throughout the world unsatisfactory impurities and or additives are needed and identified in substances. When the impurities, additives or substitutions are identified, this invention is a means and method that can be used to modify the substance, by running the substance through the container or containers holding the modification medium or mediums to modify the substance.

### DETAILED DESCRIPTION

Bypass control to deliver substance.

10 feet of ⅜ clear tubing tailored to users needs.

(12) Barbed ended screened elbows with coarse threads, screwed into the ends of each cylinder.

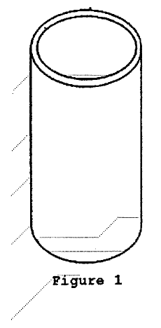

(6) Clear acrylic cylinders. FIG. 1. 11½ inches in height, 3 inches outside diameter wide, 3/16 inches wall width.

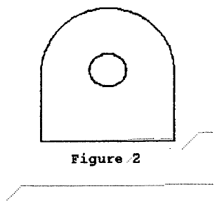

(12) Clear acrylic end caps. FIG. 2. 3¼ inch long and wide, ⅜ in thickness with one end in the shape of a half moon. With a hole centered 1¼ inches from top of curved half moon edge and a 1/2 inch hole tapped with course threads to accept one barbed ended screened elbow. Hole also used to fill or empty medium. End caps welded to the top and bottom of the cylinders. FIG. 1.

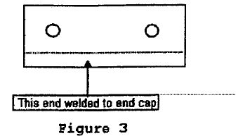

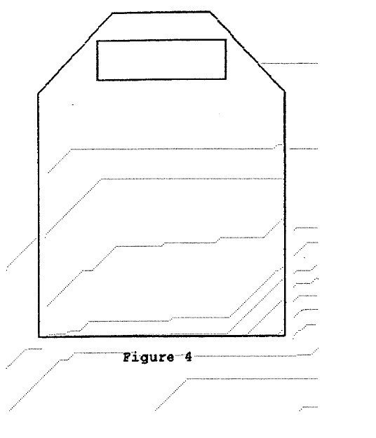

(12) Clear acrylic mounting brackets. FIG. 3. 3¼ inches wide, 1⅜ inches tall, 1/4 inch thick. Two 5/16 inch holes placed 3/8 inches from each edge and 1/2 inches from top to bolt to backing. FIG. 4. Mounting brackets are welded to end caps. FIG. 2.

Clear acrylic backing. FIG. 4. Mount 3 cylinders FIG. 1 on each side. 18 inches tall, 11¾ inches wide, 7/16 inches in thickness. Handle hole placed 1¼ inches from top, 1¼ inches tall and 5 inches wide.

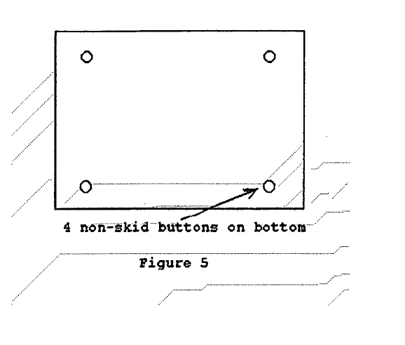

Clear acrylic base. FIG. 5. 8 inches in length, 1¾ inches in width and 7/16 inches in thickness with 4 non-skid buttons on bottom. Centered and welded to backing. FIG. 4.

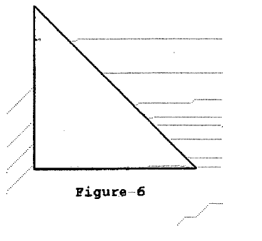

(4) Clear acrylic base and backing brace. FIG. 6. In the shape of a triangle 3¼ inch long and wide, 5/16 in thickness. Welded to base and backing FIGS. 4 & 5 outside edge.

Although certain preferred embodiments have been shown and described, it should be understood that many changes and modifications may be made therein without departing from the scope of the appended claims.

1. For demonstration purposes, a portable means and method of affecting a substance by passing it through a medium or a number of mediums to demonstrate the end results of the operation.

2. This device is a show and describe sales, marketing, research and educational tool.
